(19) United States
(12) Patent Application Publication
(10) Pub. No.: US 2013/0215515 A1
(43) Pub. Date: Aug. 22, 2013

(54) MICROLENS LAMINATE CAPABLE OF PROVIDING FLOATING IMAGE

(71) Applicants: Yasuhiro Kinoshita, Matida (JP); Jiro Hattori, Atsugi (JP)

(72) Inventors: Yasuhiro Kinoshita, Matida (JP); Jiro Hattori, Atsugi (JP)

(73) Assignee: 3M INNOVATIVE PROPERTIES COMPANY, St. Paul, MN (US)

(21) Appl. No.: 13/882,550

(22) PCT Filed: Oct. 24, 2011
(86) PCT No.: PCT/US2011/057454

§ 371 Date: Apr. 30, 2013

(30) Foreign Application Priority Data
Nov. 8, 2010 (JP) 2010-249501

(51) Int. Cl. G02B 3/00

(52) U.S. Cl. CPC G02B 3/005
USPC 359/619; 156/275.7

(57) ABSTRACT

The present disclosure provides a microlens laminate having a protected surface and exhibiting excellent appearance. The microlens laminate is capable of providing a composite image that floats above, in the plane of and/or below the laminate. The microlens laminate includes (a) a microlens sheeting comprising a microlens layer composed of a plurality of microlenses, the microlens layer having first and second sides, and a light-sensitive material layer disposed adjacent the first side of the microlens layer; and (b) a transparent material layer disposed at the second side of the microlens layer in the microlens sheeting.

### FIELD

The present disclosure relates to a microlens laminate capable of providing one or more composite images which are perceived by an observer to float in the air with respect to the laminate and in which the perspective of the composite image changes depending on the angle at which it is viewed.

### BACKGROUND

Sheeting materials having graphical images or other markings are widely used, particularly as indicators for verifying that an article or a document is authentic. For example, sheetings such as those described in U.S. Pat. Nos. 3,154,872; 3,801,183; 4,082,426; and 4,099,838 are used as authentication stickers for vehicle license plates or as safety protective films and the like for driver's licenses, official government documents, cassette tapes, playing cards, drinking containers, and the like. Other applications include graphical applications such as unique labels for the purpose of identifying patrol cars, fire engines, or other emergency vehicles or for accentuating advertising displays or brands.

An image sheeting of another form is described in U.S. Pat. No. 4,200,875 (Galanos). Galanos describes the use of an “exposure lens-type high-gain retroreflective sheeting” in which an image is formed by irradiating a sheeting with a laser through a mask or a pattern. This sheeting contains a plurality of transparent glass microspheres, parts of which are embedded in a binder layer and other parts of which are exposed above the binder layer, and the embedded surfaces of each of the plurality of microspheres are covered with a metal reflective layer. The binder layer contains carbon black, which is said to minimize stray light that hits the sheeting when an image is formed. The energy of the laser beam is further concentrated by the focusing effect of a microlens embedded in the binder layer.

An image formed by the retroreflective sheeting of Galanos can be observed only when the sheeting is viewed from the same angle as the angle at which the sheeting is irradiated by the laser. In other words, this means that the image can be seen only at an extremely limited observation angle. For this and other reasons, there is a demand for the improvement of several of the characteristics of such a sheeting.

Gabriel Lippman already invented a method for forming a true three-dimensional image of a scene with a lens-shaped medium having one or more light-sensitive layers in 1908. This method, which is called integral photography, is also described in “Processing and Display of Three-Dimensional Data II” by De Montebello in Proceedings of SPIE, San Diego, 1984. In the method of Lippman, a photographic dry plate is exposed through an array of lenses (“small lenses (lenslets)”) so that each of the lenslets of the array transfers a miniature image of the reproduced scene (viewable from the spots of the sheeting covered by the lenslets) to the light-sensitive layer on the photographic dry plate. After the photographic dry plate is developed, a three-dimensional image of the photographed scene can be seen by an observer looking at the composite image on the dry plate through the array of lenslets. This image may be in black and white or in color depending on the light sensitive material used.

Since each of the miniature images in the image formed by the lenslets during the exposure of the dry plate is inverted only one time, the three-dimensional image that is formed is a reversed image. That is, the depth recognized in the image is inverted, and the object appears to be “inside out”. In order to correct the image, two optical inversions are necessary, which is a substantial drawback. These methods are complex, and in order to record a plurality of images of the same object, it is necessary to perform a plurality of exposures using one or a plurality of cameras or a camera with a plurality of lenses. In order to provide a single three-dimensional image, it is necessary to record a plurality of images extremely accurately. Further, any method that is dependent on a conventional camera requires that an actual object be present in front of the camera. This makes the method even more unsuitable for forming a three-dimensional image of a virtual object (an object that gives the impression of existing but does not actually exist). Another drawback of integral photography is that the composite image must be irradiated with light from the viewing side in order to generate an actual visible image.

PCT International Publication No. WO 01/63341 describes a “sheeting material comprising a composite image provided by a. at least one microlens layer having first and second sides, b. a material layer disposed adjacent the first side of the microlens, c. at least partially complete images which are formed in the material so that they are connected to each of the plurality of microlenses and have contrast with the material, and d. individual images which appear to the naked eye to float above, below, or both above and below the sheeting material.”

PCT International Publication No. WO 2009/009258 describes a “method comprising irradiating a sheeting having a microlens surface with an energy light beam to form a plurality of images in the sheeting, wherein the center of the energy light beam is misaligned with the normal line of the surface of the sheeting; at least one image formed in the sheeting is a partially complete image, each image being associated with a different microlens in the sheeting; and each microlens has a refractive surface which sends light to a plurality of positions in the sheeting in order to generate one or more composite images which appear to float with respect to the surface of the sheeting.”

The present disclosure provides a microlens laminate having a protected surface and excellent appearance.

### SUMMARY

One aspect of the present disclosure provides a microlens laminate capable of providing a composite image that floats above, in the plane of, and/or below the laminate, the microlens laminate including: a microlens sheeting including a microlens layer composed of a plurality of microlenses, the microlens layer having first and second sides, and a light-sensitive material layer disposed adjacent the first side of the microlens layer; and a transparent material layer disposed at the second side of the microlens layer in the microlens sheeting.

Another aspect of the present disclosure provides a method of making a microlens laminate capable of providing a composite image that floats above, in the plane of, and/or below the laminate, the method including: providing a microlens sheeting including a microlens layer composed of a plurality of microlenses, the microlens layer having first and second sides, and a light-sensitive material layer disposed adjacent the first side of the microlens layer; providing a transparent material layer; and attaching the transparent material layer to the microlens sheeting at the second side of the microlens layer with an optically clear layer to form a microlens laminate.

Yet another aspect of the present disclosure provides a method of making a microlens laminate capable of providing a composite image that floats above, in the plane of, and/or below the laminate, the method including: providing a microlens sheeting including a microlens layer composed of a plurality of microlenses, the microlens layer having first and second sides, and a light-sensitive material layer disposed adjacent the first side of the microlens layer; and directly forming a transparent material layer on the microlens sheeting at the second side of the microlens layer to form a microlens laminate.

The microlens laminate can be used to provide one or more composite images that float above, in the plane of, and/or below the laminate or may have such composite images. A composite image is formed from at least partially complete individual images formed in the light-sensitive material layer, each image associated with a respective microlens of the plurality of microlenses. These floating composite images are sometimes called floating images for the sake of convenience, and they refer to images formed by the aggregation of points through which a beam of light having the same trajectory as that of a beam of light generated by the floating luminescent points passes in a concentrated manner. These floating images can appear to be positioned above or below the laminate (as a two-dimensional or three-dimensional image) or appear as a three-dimensional image appearing above, in the plane of, or below the laminate. The floating images may also appear to move continuously from a certain height or depth to another height or depth. The floating images may be in black and white or in color and can also appear to move with the observer. The floating images can be viewed by the observer with the naked eye. The term “floating image” may also be used synonymously with the term “virtual image”.

A floating image can be formed in a microlens sheeting by irradiating the sheeting with light via an optical system array (train), for example, using a light source. In this disclosure, “light” refers to electromagnetic waves such as ultraviolet rays, visible light rays, and infrared light rays, for example, with a wavelength of at least approximately 1 nm and at most approximately 1 mm, regardless of the type of light source. The energy of incident light hitting the microlens sheeting is focused in certain regions in the microlens sheeting by the individual microlenses. This focused energy alters the light-sensitive material layer to form a plurality of individual images having sizes, shapes, and appearances, which depend on interactions between the light rays and the microlenses. For example, the light rays can form individual images associated with each of the microlenses in the microlens sheeting. The microlenses have refractive surfaces, which send light to a plurality of positions in the microlens sheeting to generate one or more composite images from the individual images.

A floating image of the microlens laminate may contain a plurality of (visible) composite images shown by the images formed in the microlens sheeting. Each of the composite images may also be associated with different viewing angle ranges so that each composite image can be viewed from a different viewing angle of the laminate. In a certain aspect, different composite images can be displayed with the images formed in the microlens sheeting, and these different composite images may have different viewing angle ranges. In this example, two observers positioned at different viewing angles with respect to the microlens laminate can see different composite images from the laminate. In another aspect, the same composite image may be formed across a plurality of viewing angle ranges. In some cases, the viewing angle ranges may overlap to provide a greater continuous viewing angle range. As a result, the composite image can be seen from a much larger viewing angle range than originally possible.

Since the microlens laminate of the present disclosure has a protected surface, it has excellent durability and an excellent appearance; in particular, a lustrous appearance. The microlens laminate of the present disclosure can be suitably used for a wide range of applications ranging from, for example, applications related to relatively small objects such as emblems, tags, identification badges, identification graphics, and affiliated credit cards to applications related to relatively large objects such as advertisements and license plates.

The above description should not be considered a disclosure of all of the aspects of the present disclosure or all of the advantages related to the present disclosure.

### BRIEF DESCRIPTION OF THE DRAWINGS

This disclosure may be more completely understood in connection with the following with the following figures:

FIG. 1 is an enlarged cross-sectional view of the microlens laminate of one aspect of the present disclosure.

FIG. 2 is an enlarged cross-sectional view of the microlens laminate of another aspect of the present disclosure.

FIG. 3 is an enlarged cross-sectional view of the microlens laminate of yet another aspect of the present disclosure.

FIG. 4 is a schematic illustration of divergent energy hitting a microlens sheeting composed of microspheres.

FIG. 5 is a plan view of a part of the microlens sheeting showing sample images recorded on the light-sensitive material layer adjacent individual microspheres and further shows that the recorded images are within a range from complete reproduction to partial reproduction of the composite image.

FIG. 6 is an optical microscope photograph of a microlens sheeting having a light-sensitive material layer made from an aluminum film with images formed so that it provides a composite image that floats above the laminate in accordance with the present disclosure.

FIG. 7 is an optical microscope image of a microlens sheeting having a light-sensitive material layer made from an aluminum film with images formed so that it provides a composite image that floats below the laminate in accordance with the present disclosure.

FIG. 8 is a geometrical optical schematic illustration showing the formation of a composite image that floats above the microlens laminate.

FIG. 9 is a schematic illustration of a laminate having a composite image that floats above the microlens laminate when the microlens laminate is viewed with reflected light.

FIG. 10 is a schematic illustration of a laminate having a composite image that floats above the microlens laminate when the microlens laminate is viewed with transmitted light.

FIG. 11 is a geometrical optical schematic illustration showing the formation of a composite image that floats below the microlens laminate.

FIG. 12 is a schematic illustration of a laminate having a composite image that floats below the microlens laminate when the microlens laminate is viewed with reflected light.

FIG. 13 is a schematic illustration of a laminate having a composite image that floats below the microlens laminate when the microlens laminate is viewed with transmitted light.

FIG. 14 is a schematic illustration of an optical system array for generating the divergent energy used to form a composite image.

This disclosure is amendable to various modifications and alternative forms. Specifics thereof have been shown by way of example in the drawings, which will be described in detail. It should be understood that the intention is not to limit the disclosure to the particular embodiments described. Instead, the intention is to cover all modifications, equivalents and alternatives falling within the scope and spirit of the disclosure as defined by the appended claims.

### DETAILED DESCRIPTION

The microlens laminate of one aspect of the present disclosure includes a microlens sheeting and a transparent material layer. The microlens sheeting includes a microlens layer composed of a plurality of microlenses, the microlens layer having first and second sides, and a light-sensitive material layer disposed adjacent the first side of the microlens layer. The transparent material layer is disposed at the second side of the microlens layer in the microlens sheeting. The microlens laminate can provide a composite image that floats above, in the plane of, and/or below the microlens laminate by forming images in the microlens sheeting using the image forming method described below. In the present disclosure, “transparent” means that transmittance of light of a target wavelength is at least approximately 50%, and it is advantageous for this transmittance to be at least approximately 70% and at most approximately 90%.

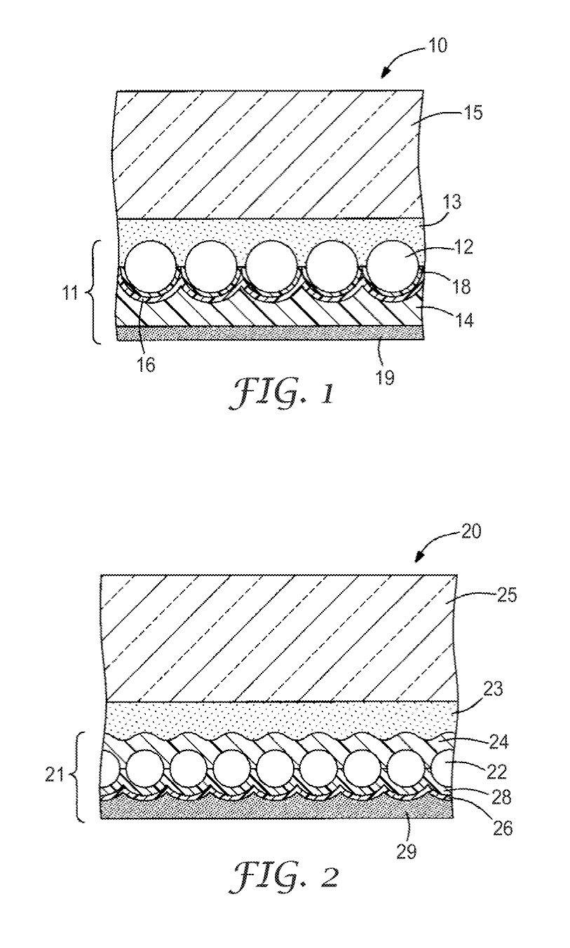

FIG. 1 is an enlarged cross-sectional view of the microlens laminate of one aspect of the present disclosure. A microlens laminate 10 is formed by laminating a microlens sheeting 11, an optically clear adhesive layer 13, and a transparent material layer 15, and the transparent material layer 15 is attached to the second side of the microlens layer in the microlens sheeting 11 via the optically clear adhesive layer 13.

In the microlens sheeting 11, transparent microspheres 12 are partially embedded in a binder layer 14 to form a microlens layer composed of a plurality of microlenses. The microspheres 12 are transparent with respect to both light of a wavelength used to form images on a light-sensitive material layer 16 and light of a wavelength for observing the composite image. The light-sensitive material layer 16 is disposed on a surface of the back part of each of the microspheres via a transparent spacer layer 18. The spacer layer 18 is provided to correct optical effects caused by the optically clear adhesive layer 13 and the transparent material layer 15 as necessary. The microlens sheeting 11 may also have an adhesive layer 19 as an outermost layer on the first side of the microlens layer as necessary and a peel liner (not shown) thereon as necessary. This type of sheeting is described in detail in U.S. Pat. No. 2,326,634.

Each of the plurality of microlenses forming the microlens layer has a refractive surface so that image formation may occur. The refractive surface is typically a curved microlens surface. It is preferable for the curved surfaces of the microlenses to have uniform refractive indices. Other useful materials that provide a graded refractive index (GRIN) do not necessarily require a curved surface to refract light. The microlens surface is preferably essentially spherical, but it may also be a non-spherical surface. The microlenses may have arbitrary symmetries such as cylindrical or spherical shapes. The microlenses themselves may have distinct shapes such as round plano-convex lenslets, round double convex lenslets, rods, microspheres, beads, or cylindrical lenslets. Materials with which microlenses can be formed include glass, polymers, inorganic materials, crystals, semiconductors, and combinations of these with other materials. Microlens elements which are not distinct (that is, a plurality of microlens elements which are integrated) can also be used. Accordingly, microlenses formed by replicating or embossing (whereby the shape of the sheeting surface is changed to form a repeating shape having image-forming characteristics) can also be used.

Microlenses having a uniform refractive index of at least approximately 1.5 or 1.7 and at most approximately 2.0 or 3.0 across the wavelengths of ultraviolet rays, visible light rays, and infrared rays can be used advantageously. It is advantageous for the microlens material to be able to not only absorb visible light rays, but also to absorb the energy source used to form images in the light-sensitive material layer. Whether they are distinct microlenses or replicating-type microlenses, the refractive power of the microlenses refracts incident light on the refractive surface toward the opposite side of each microlens and thereby focuses the light, regardless of the material out of which the microlenses are formed. More specifically, incident light is focused on the light-sensitive material layer adjacent the microlenses on the back of the microlenses, and the microlenses form reduced versions of the real image at appropriate positions on the layer. Setting an image reduction ratio to at least approximately 100× and at most approximately 800× is advantageous for forming images having good resolution. The configuration of a microlens sheeting for providing the focusing conditions necessary to allow the energy incident on the refractive surfaces of the microlenses to be focused on the light-sensitive material layer is described in the U.S. patents referenced previously in this section.

It is preferable for the microlenses to be microspheres having a diameter within the range of at least approximately 15 μm and at most approximately 1000 μm, but microspheres of any size may be used. A composite image with a good resolution can be obtained by using microspheres having a diameter toward the smaller end of this range for a composite image, which will appear to be moving away from the microlens layer over a relatively short distance, and by using larger microspheres for a composite image, which will appear to be moving away from the microlens layer over a longer distance. Other microlenses such as plano-convex, cylindrical, spherical, or non-spherical microlenses having lenslet dimensions equivalent to the microspheres shown above can also be expected to yield similar optical results.

The light-sensitive material layer is disposed adjacent to the first side of the microlens layer. The light-sensitive material layer may have high or low reflectivity. If the reflectivity of the light-sensitive material layer is high, the microlens sheeting may have a retroreflective ability such as that described in U.S. Pat. No. 2,326,634. When an observer views the sheeting under reflected light or transmitted light, the individual images formed in the light-sensitive material layer in association with respective lenses of the plurality of microlenses provide a composite image that is floating above, in the plane of, and/or below the microlens laminate.

Useful light-sensitive material layers include coatings or films made of metals, polymers, semiconductor materials, and combinations thereof. In the present disclosure, “light-sensitive” refers to a material in which, when the material is exposed to a certain level of visible light rays or light of another wavelength, the appearance of the exposed material changes to form a contrast with materials that have not been exposed to light. Accordingly, an image is formed by variation in the composition of the light-sensitive material layer or the removal, abrasion, phase change, or polymerization of the material. Examples of light-sensitive metal materials include aluminum, silver, copper, gold, titanium, zinc, tin, chromium, vanadium, tantalum, and alloys of these metals. These metals typically produce a contrast due to differences in the original color of the metal and the altered color of the metal after exposure to light. This image can be provided by abrasion or by light of a wavelength, which heats the material until an image is generated by optical transformation in the material. For example, the heating of a metal alloy for providing variation in color is described in U.S. Pat. No. 4,743,526. If aluminum, for example, is used as the light-sensitive material, image formation can be implemented using a YAG laser, for example. If a common light-sensitive polymer material, for example, is used as the light-sensitive material, image formation can be implemented with visible light rays or ultraviolet rays.

In addition to metal alloys, metal oxides or metal suboxides can be used as the light-sensitive material layer. This class of materials includes oxide compounds of aluminum, iron, copper, tin, and chromium. Non-metal materials such as zinc sulfide, zinc selenide, silicon dioxide, indium tin oxide, zinc oxide, magnesium fluoride, and silicon, for example, can also provide useful colors or contrasts.

Multilayer thin-film materials can also be used for the light-sensitive material layer. These multilayer materials can be configured so that they provide variation in contrast as a result of the appearance or removal of a colorant or a contrast agent. An example of such a configuration is an optical stack or a tuned cavity designed so that an image is formed by light of a specific wavelength (as the color changes, for example). A specific example is described in U.S. Pat. No. 3,801,183, wherein it is described that cryolite/zinc oxide (Na₃AlF₆/ZnS) is used as a dielectric mirror. Another example is an optical stack composed of chromium/polymer (for example, plasma polymerized butadiene)/silicon dioxide/aluminum, wherein the thickness of the chromium layer is approximately 4 nm, the thickness of the polymer layer is within the range of at least approximately 20 nm and at most approximately 60 nm, the thickness of the silicon dioxide layer is within the range of at least approximately 20 nm and at most approximately 60 nm, and the thickness of the aluminum layer is within the range of at least approximately 80 nm and at most approximately 100 nm. The thickness of each layer is selected so that it provides a specific color reflectance in the visible spectrum. A thin-film tuned cavity can be formed using the aforementioned single-layer thin films. For example, in a tuned cavity having a chromium layer with a thickness of approximately 4 nm and a silicon dioxide layer with a thickness of at least approximately 100 nm and at most approximately 300 nm, the thickness of the silicon dioxide layer is adjusted so that it provides a colorized image in response to light of a specific wavelength.

Another useful light-sensitive material is a thermochromic material. “Thermochromic” refers to a substance having a color that changes when exposed to changes in temperature. Examples of useful thermochromic materials are described in U.S. Pat. No. 4,424,990, wherein copper carbonate, copper nitrate involving thiourea, and copper carbonate involving sulfur-containing compounds (for example, thiol, thioether, sulfoxide, and sulfone) are disclosed. Other examples of appropriate thermochromic materials are described in U.S. Pat. No. 4,121,011, wherein hydrated sulfates and nitrates of boron, aluminum, and bismuth, and oxides and hydrated oxides of boron, iron, and phosphorus are disclosed.

The spacer layer contains a polymer material which may be the same as or different from the polymer material of the binder layer (described below). Examples of polymer materials include urethane, ester, ether, urea, epoxy, carbonate, acrylate, acryl, olefin, vinyl chloride, amide, and alkyd units or combinations thereof. The polymer material may contain a silane coupling agent or the like, and it may also be a cross-linked polymer. The spacer layer is transparent with respect to both light of the wavelength used to form images on the light-sensitive material layer and light of the wavelength for observing the composite image. The thickness of the spacer layer is adjusted based on the refractive index of the transparent material layer and the optically clear adhesive layer, as described below. In this way, any optical effects caused by the transparent material layer and the optically clear adhesive layer can be corrected. It is not necessary to use a spacer layer in cases in which the optical effects caused by the transparent material layer and the optically clear adhesive layer can be corrected in advance by the refractive index of the microlens material and/or the design of a refractive surface.

The binder layer is a layer that essentially supports the microspheres of the microlens layer, and it is typically made of a polymer material. The binder layer is unnecessary in cases in which the optically clear adhesive layer described below also functions as a binder layer or in the case of replication-type microlenses in which the individual microlenses are not separated. Examples of the polymer material of the binder layer include those described for the spacer layer. The polymer layer may contain a silane coupling agent or the like, and it may also be a cross-linked polymer. In the aspect shown in FIG. 1, although it is not necessary for the binder layer to be transparent with respect to both light of the wavelength used to form images on the light-sensitive material layer and light of the wavelength for observing the composite image, if it is transparent with respect to light of the wavelength for observing the composite image, the composite image can be observed under not only reflected light, but also transmitted light. The thickness of the binder layer can be selected appropriately based on the diameter of the microspheres, and it is typically at least approximately 1 μm or approximately 50 μm and at most approximately 250 μm or approximately 150 μm.

The microlens sheeting may further contain an adhesive layer for adhering to another substrate as the outermost layer on the first side of the microlens layer. A known adhesive or a pressure-sensitive adhesive in this technical field can be used as the material of the adhesive layer. In addition, a known substance in this technical field such as paper or a film having a silicon peel coating can be used as the peel liner. If the adhesive layer is transparent with respect to light of the wavelength for observing the composite image, the composite image can be observed not only under reflected light, but also under transmitted light.

A material which is transparent to light of the wavelength for observing the composite image—that is, a material for which the transmittance of light of the wavelength for observing the composite image is at least approximately 50% or, more advantageously, at least approximately 70% or 90%—can be used as the transparent material layer, and examples include glass, acrylic resins such as polymethylmethacrylate (PMMA), epoxy resins, silicon resins, urethane resins, and polycarbonates. The shape of the transparent material layer may vary depending on the application as long as it is optically flat, and a layer in which the surface shape or three-dimensional shape is provided by injection molding, embossing, or the like can also be used. The thickness of the transparent material layer may vary depending on the application, and it is typically at least approximately 50 μm and at most approximately 20 mm. The refractive index of the transparent material layer differs from the refractive index of the microlens material, and the refractive index difference Δn₁ between the transparent material layer and the microlens material defined by the formula:

Δn₁=n (refractive index of the microlens material)−n (refractive index of the transparent material layer)

is at least approximately 0.3, 0.5, or 0.7 for light of the wavelength used for image formation and for light of the wavelength for observing the composite image. The size of Δn₁, the design of the dimensions and refractive surfaces of the microlenses, the refractive index of the microlens material, and the thickness of the spacer layer are adjusted so that the energy that is incident on the refractive surfaces of the microlenses at the time of image formation can be appropriately focused on the light-sensitive material layer. A larger Δn₁ is generally advantageous for reducing the thickness of the spacer layer. The transparent material layer may also have another decorative layer such as gold leaf or a silk-screen printed layer. A combination of such a decorative layer and a floating image makes it possible to produce unique visual effects, which were previously unattainable.

An optically clear adhesive or pressure-sensitive adhesive can be used as the material of the optically clear adhesive layer, and the optically clear adhesive layer can, for example, include an optically clear pressure-sensitive adhesive, an optically clear liquid adhesive, or an optically clear hot melt adhesive. In the present disclosure, “optically clear” means that the adhesive or the pressure-sensitive adhesive and the adhesive layer formed from them are transparent with respect to at least light of the wavelength for observing the composite image. Therefore, according to the definition in the present disclosure, it is advantageous for the transmittance of light of the wavelength for observing the composite image in the adhesive or the pressure-sensitive adhesive and the adhesive layer formed from them to be at least approximately 50%, 70% or 90%. The adhesive or the pressure-sensitive adhesive and the adhesive layer formed from them may also be transparent with respect to light of other wavelengths. The optically clear adhesive layer can be formed with adhesives or pressure-sensitive adhesives of various forms such as sheet-like or liquid (single liquid, double liquid, etc.) adhesives, and the adhesives or pressure-sensitive adhesives may be thermosetting or ultraviolet-setting adhesives. The thickness of the optically clear adhesive layer may vary depending on the application, and it is generally practically advantageous for it to be at least approximately 10 μm and at most approximately 500 μm or at least approximately 50 μm and at most approximately 200 μm. The refractive index of the optically clear adhesive layer differs from the refractive index of the microlens material, and the refractive index difference Δn₂ between the optically clear adhesive layer and the microlens material defined by the formula:

Δn₂=n (refractive index of the microlens material)−n (refractive index of the optically clear adhesive layer)

is at least approximately 0.3, 0.5, or 0.7 for light of the wavelength used for image formation and for light of the wavelength for observing the composite image. The size of Δn₂, the design of the dimensions and refractive surfaces of the microlenses, the refractive index of the microlens material, and the thickness of the spacer layer are adjusted so that the energy that is incident on the refractive surfaces of the microlenses at the time of image formation can be appropriately focused on the light-sensitive material layer. A larger Δn2 is generally advantageous for reducing the thickness of the spacer layer.

The adhesives or pressure-sensitive adhesives which can be used for the optically clear adhesive layer are various and are not particularly limited, and they include acrylic adhesives or pressure-sensitive adhesives, rubber adhesives, epoxy adhesives, silicon adhesives, urethane adhesives, and the like. Acrylic adhesives or pressure-sensitive adhesives are preferable from the perspective of weather resistance and the adhesive force between the microlens sheeting and the transparent material layer. Acrylic adhesives or pressure-sensitive adhesives will be described in detail below.

Acrylic adhesives or pressure-sensitive adhesives are derived from a plurality of (metha)acrylate monomers and are designed while taking into consideration the glass transition temperature (Tg), the cohesive force, the wettability, the low-temperature properties, the high-temperature properties, and the like of the (metha)acrylate polymers derived from each of the (metha)acrylate monomers. In the present disclosure, “(metha)acryl” refers to “acryl” or “methacryl”; “(metha)acrylate” refers to “acrylate” or “methacrylate”; “(metha)acryloyl” refers to “acryloyl” or “methacryloyl”; and “(metha)acrylonitrile” refers to “acrylonitrile” or “methacrylonitrile”. A (metha)acrylate polymer may, for example, be derived from a combination of another ethylenically unsaturated monomer and/or an acidic monomer and the (metha)acrylate monomer described, or it may be graft-copolymerized with a reinforcing polymer part.

(Metha)acrylates of non-tertiary alkyl alcohols with an alkyl group carbon number between 1 and approximately 18 and preferably between approximately 4 and 12 and mixtures thereof can be advantageously used as (metha)acrylate monomers. Examples of suitable (metha)acrylate monomers, while not limited to the following, include methyl acrylate, ethyl acrylate, methyl methacrylate, ethyl methacrylate, n-butyl acrylate, n-butyl methacrylate, isobutyl acrylate, isobutyl methacrylate, hexyl acrylate, hexyl methacrylate, 2-ethylhexyl acrylate, 2-ethylhexyl methacrylate, isoamyl acrylate, isooctyl acrylate, isononyl acrylate, decyl acrylate, isodecyl acrylate, isodecyl methacrylate, lauryl acrylate, lauryl methacrylate, 2-methylbutyl acrylate, 4-methyl-2-pentyl acrylate, ethoxy ethoxyethyl acrylate, 4-t-butylcyclohexyl methacrylate, cyclohexyl methacrylate, phenyl acrylate, phenyl methacrylate, 2-naphthyl acrylate, 2-naphthyl methacrylate, and mixtures thereof. 2-Ethylhexyl acrylate, isooctyl acrylate, lauryl acrylate, n-butyl acrylate, ethoxy ethoxyethyl acrylate, and mixtures thereof can be used particularly advantageously. The quantity of (metha)acrylate monomers used is at least 50% mass percent based on the total mass of the monomers.

Examples of other ethylenically unsaturated monomers, while not limited to the following, include vinyl esters (for example, vinyl acetate, vinyl pivalate, and vinyl neononate), vinyl amides, N-vinyl lactams (for example, N-vinyl pyrrolidone and N-vinyl caprolactam), (metha)acrylamides (for example, N,N-dimethylacrylamide, N,N-dimethylmethacrylamide, N,N-diethylacrylamide, and N,N-diethylmethacrylamide), (metha)acrylonitriles, maleic anhydride, styrene and substituted styrene derivatives (for example, α-methyl styrene), and mixtures thereof. The quantity of other ethylenically unsaturated monomers used is at most 30 mass percent based on the total mass of the monomers.

Acidic monomers with arbitrary ingredients may be used for the preparation of (metha)acrylate polymers. Useful acidic monomers, while not limited to the following, include substances selected from ethylenically unsaturated carboxylic acid, ethylenically unsaturated sulfonic acid, ethylenically unsaturated phosphonic acid, and mixtures thereof. Examples of such a compound include substances selected from acrylic acid, methacrylic acid, itaconic acid, fumaric acid, crotonic acid, citraconic acid, maleic acid, β-carboxyethyl acrylate, 2-sulfoethyl methacrylate, styrene sulfonic acid, 2-acrylamide-2-methylpropane sulfonic acid, vinyl phosphonic acid, and mixtures thereof. The quantity of acid monomers used is at most 20 mass percent based on the total mass of the monomers.

The acrylic adhesive or pressure-sensitive adhesive may also contain (metha)acrylate polymers having groups capable of cross-link formation. A group capable of cross-link formation refers to a group capable of forming a cross-linked structure in the acrylic adhesive or pressure-sensitive adhesive polymer. A cross-linked structure can increase the cohesive force of the acrylic adhesive or pressure-sensitive adhesive polymer. Groups capable of cross-link formation include functional groups having reactivity with cross-linking agents such as multifunctional isocyanates, epoxies, and aziridine compounds, and an example is a hydroxyl group. Hydroxyl groups react with multifunctional isocyanates to form cross-links with urethane bonds. Examples of monomers having such groups capable of cross-link formation include 2-hydroxyethyl acrylate, 2-hydroxyethyl methacrylate and 2-hydroxypropyl acrylate. The groups capable of cross-link formation may be radical polymerizable groups such as (metha)acryloyl groups, and in this case a cross-linking agent is not required since a cross-linking reaction is induced simultaneously with the polymerization for generating polymers. Acrylate monomers having such groups include 1,2-ethyleneglycol di-(metha)acrylate, 1,4-butanediol di-(metha)acrylate and 1,6-hexanediol di-(metha)acrylate.

If the transparent material layer and the optically clear adhesive layer are transparent with respect to light of the wavelength used to form images on the light-sensitive material layer, image formation can be implemented by irradiating the transparent material layer with light from above after forming the microlens laminate. This makes it possible to switch the order of the step for processing the shape of the microlens laminate and the image forming step, which in turn makes it possible to flexibly accommodate partial outsourcing of the manufacturing process or on-demand production.

The surface of the microlens layer of the microlens laminate according to this aspect is protected by the transparent material layer, which prevents the micropheres from dropping out of the microlens layer, and this results in excellent durability against friction, impacts, and the like. This aspect can also provide the microlens laminate with a surface having an excellent appearance—in particular, a lustrous appearance or ornamentation—due to the transparent material layer.

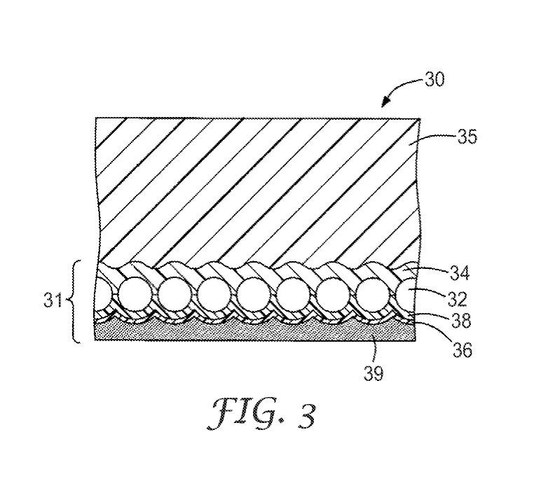

FIG. 2 is an enlarged cross-sectional view of the microlens laminate of another aspect of the present disclosure. A microlens laminate 20 is formed by laminating a microlens sheeting 21, an optically clear adhesive layer 23, and a transparent material layer 25, and the transparent material layer 25 is attached to the second side of the microlens layer in the microlens sheeting 21 via the optically clear adhesive layer 23.

In the microlens sheeting 21, transparent microspheres 22 are partially embedded in a binder layer 24 to form a microlens layer composed of a plurality of microlenses. The binder layer 24 ordinarily has concavities and convexities on the surface completely or incompletely conforming to the shapes of the surfaces of the microlenses 22, and the microlens sheeting 21 sometimes gives an appearance of an orange peel prior to lamination. The microspheres 22 are transparent with respect to both light of the wavelength used to form images on a light-sensitive material layer 26 and light of the wavelength for observing the composite image. The light-sensitive material layer 26 is disposed on the surface of a back part of each of the microspheres via a transparent spacer layer 28. The spacer layer 28 is provided to correct optical effects caused by the optically clear adhesive layer 23 and the transparent material layer 25 as necessary. The microlens sheeting may also have an adhesive layer 29 as an outermost layer on the first side of the microlens layer as necessary and a peel liner (not shown) thereon as necessary. This type of sheeting is described in detail in U.S. Pat. No. 3,801,183. Another suitable type of microlens sheeting is called an enclosed lens sheeting, an example of which is described in U.S. Pat. No. 5,064,272.

In this aspect, the binder layer is disposed on the second side of the microlens layer—that is, on the side where the light used for image formation is incident—so it is transparent with respect to both light of the wavelength used to form images on the light-sensitive material layer and light of the wavelength for observing the composite image. All other components of the microlens sheeting in this aspect (the microlenses, the light-sensitive material layer, the spacer layer, the binder layer, the adhesive layer, and the peel liner) as well as the optically clear adhesive layer and the transparent material layer are as described in the aspect shown in FIG. 1, including the suitable modes and resulting advantages.

In this aspect, the optically clear adhesive layer and the transparent material layer can be directly laminated on a commercially available microlens sheeting without changing the design of the microlenses or the spacer layer by making the refractive indices of the optically clear adhesive layer and the transparent material layer approximately the same as the refractive index of the binder layer for light of the wavelength used for image formation and light of the wavelength for observing the composite image. It is advantageous for the difference between the refractive indices of the optically clear adhesive layer and the transparent material layer and the refractive index of the binder layer to be at most approximately 0.1, 0.05 or 0.03 for light of the wavelength used for image formation and light of the wavelength for observing the composite image. In this way, the appearance of a commercially available microlens sheeting giving off the appearance of an orange peel can be easily improved.

If the microlens sheeting contains a polyvinylchloride (PVC) binder layer, bleedout of the plasticizer contained in the PVC or whitening due to contact with other objects may occur, but these problems are prevented from occurring in this aspect by covering the binder layer with the transparent material layer.

The microlens laminates of the aspects described thus far can be formed by attaching the transparent material layer to the second side of the microlens layer in the microlens sheeting via the optically clear adhesive layer described above, and known methods can be used for the lamination method and the methods for applying and setting the adhesive or pressure-sensitive adhesive. Image formation may also be implemented on the microlens sheeting in advance using the image formation method described below before the microlens laminate is formed. If the optically clear adhesive layer, the transparent material layer, and, as necessary the binder layer used on the second side of the microlens layer are transparent with respect to light of the wavelength used to form images on the light-sensitive material layer, image formation can be implemented after the microlens laminate is formed.

In yet another aspect of the present disclosure shown in FIG. 3, a transparent material layer 35 is molded directly on a microlens sheeting 31 on the second side of the microlens layer of the microlens sheeting 31. In this aspect, the transparent material layer 35 itself has adhesiveness with respect to the microlens sheeting 31, and a microlens laminate is formed without using another separate adhesive layer.

A material that is transparent with respect to light of the wavelength for observing the composite image, as described above, and has adhesiveness can be used as the transparent material layer, and examples include thermosetting or ultraviolet-setting acrylic resins, epoxy resins, silicon resins, and urethane resins. A transparent material layer composed of these resins can be molded directly on the microlens sheeting by a known means such as potting or die molding This aspect provides the transparent material layer with shape during the molding process and is therefore particularly advantageous when creating a microlens laminate having a three-dimensional shape. The microlens laminate can also be provided with a buffering (impact absorption) function by using a silicon resin, a urethane resin, or the like having elasticity.

The shape, thickness, refractive index, the decorative layer, and the like of the transparent material layer and the components of the microlens sheeting (the microlenses, the light-sensitive material layer, the spacer layer, the binder layer, the adhesive layer, and the peel liner) are as described in the aspect shown in FIG. 1, including the suitable modes and resulting advantages. In this aspect as well, if the transparent material layer is also transparent with respect to light of the wavelength used to form images on the light-sensitive material layer, image formation can be implemented by irradiating the transparent material layer with light from above after forming the microlens laminate. This makes it possible to switch the order of the step for processing the shape of the microlens laminate and the image forming step, which in turn makes it possible to flexibly accommodate partial outsourcing of the manufacturing process or on-demand production.

The transparent material layer and/or the optically clear adhesive layer may contain a visibility enhancer selected from a group consisting of light diffusing materials and combinations thereof. A visibility enhancer refers to an agent capable of magnifying the viewing angle by scattering light at spatial positions where the floating composite image appears (image formation point). It is also sometimes possible to increase the contrast between the composite image and the background by adding the visibility enhancer. Light diffusing materials that can be used as visibility enhancers include titania, zirconia, and silica.

The transparent material layer, the optically clear adhesive layer, the spacer layer, and the binder layer may also contain other ingredients such as colorants (for example, pigments, dyes, and metal flakes), fillers, stabilizers (for example, heat stabilizers, antioxidants such as hindered phenol, and light stabilizers such as hindered amine or ultraviolet stabilizers), and flame retardants within a range that does not inhibit the implementation of the present disclosure.

An illustrative method for forming an image on the microlens laminate of the present disclosure will be described hereinafter with reference to the drawings. The transparent material layer, the optically clear adhesive layer, other components, and their reference symbols may be omitted from the drawings for the sake of explanatory convenience and for the purpose of simplifying the drawings.

A suitable method for providing the light-sensitive material layer adjacent the first side of the microlens layer with an image pattern is to form an image in the light-sensitive material layer using a light source. In the method of the present disclosure, any energy source that provides light having the desired intensity and wavelength can be used. An apparatus capable of generating light having a wavelength between 200 nm and 11 μm is considered particularly advantageous. Examples of useful high-peak output light sources include excimer flash lamps, passively Q-switched microchip lasers, Q-switched neodymium-doped yttrium aluminum garnet (abbreviated as Nd:YAG), neodymium-doped yttrium lithium fluoride (abbreviated as Nd:YLF), and titanium-doped sapphire (abbreviated as Ti:sapphire) lasers. These high-peak output light sources are particularly useful when using a light-sensitive material layer on which an image is formed by abrasion (removing the material) or via a multiple-photon absorption process. Other examples of useful light sources include devices providing low-peak output such as laser diodes, ion lasers, non-Q-switched solid lasers, metal vapor lasers, gas lasers, arc lamps, and high-output white heat light sources, for example. These light sources are particularly useful when an image is formed on the light-sensitive material layer by a non-abrasive method.

The energy from the light source is controlled so that it moves toward the microlenses to generate highly divergent energy light rays. Light generated by an energy source for the ultraviolet ray, visible light ray, and infrared ray portions of the electromagnetic spectrum is controlled by an appropriate optical element (this example is shown in FIG. 14 and described in detail below). In one aspect, a requirement of the arrangement of this optical element (generally called an optical system array) is that the optical system array directs the light toward the microlenses by appropriate divergence or spreading so that the microlenses and, as a result, the light-sensitive material layer are irradiated at the desired angle. The composite image in the present disclosure is obtained by using a light diffusing element preferably having a numerical aperture of at least approximately 0.3 (defined as the sine of the half angle of the maximum divergent light rays). A light diffusing element having a larger numerical aperture produces a composite image having a larger viewing angle and apparent image movement over a larger range.

An example of the image formation method of the present disclosure includes directing parallel light to the microlenses from a laser via lenses. As will be described later, in order to form a microlens laminate having a floating image, light is sent via a diverging lens having a high numerical aperture (NA) to generate a cone of highly divergent light. A high-NA lens is a lens having an NA of at least approximately 0.3. The light-sensitive material layer side of the microlenses (for example, microspheres) is disposed at a distance from the lens so that the axis of the cone of light (optical axis) is perpendicular to the plane of the microlens sheeting.

Each of the microlenses occupies a unique position with respect to an optical axis, so light that hits each of the microlenses has a unique angle of incidence with respect to the light incident on each of the other microlenses. Light is thus sent to a unique position of the light-sensitive material layer by each of the microlenses to generate a unique image. More precisely, since a single light pulse only generates a single image forming dot on the light-sensitive material layer, a plurality of light pulses are used to form an image adjacent to each of the microlenses, and this image is created by the plurality of image forming dots. The optical axis of each pulse is disposed at a new position with respect to the position of the optical axis of the previous pulse. These continuous changes in the positions of the optical axes with respect to the microlens induce changes corresponding to the angle of incidence on each of the microlenses and therefore induce changes in the positions of the image forming dots created by the light-sensitive material layer. As a result, an image with the selected pattern is formed in the light-sensitive material layer by the incident light focused on the back side of the microlenses (for example, microspheres). Since the position of each microlens is unique with respect to every optical axis, the image formed in the light-sensitive material layer for each microlens differs from the images associated with all of the other microlenses.

In another method for forming a floating image, highly dispersed light is generated using a lens array to form an image in the light-sensitive material layer. The lens array consists of a plurality of lenslets having a high numerical aperture disposed with a planar structure. When the array is irradiated with light by a light source, the array generates a plurality of cones of highly dispersed light, and each of the cones focuses on each of the corresponding lenses in the array. The physical dimensions of the array are selected to achieve the maximum size of the composite image in the horizontal direction. Due to the size of the array, the individual cones of energy formed by the lenslets irradiate the microlenses as if each of the lenses were sequentially positioned at all of the points on the array when receiving light pulses. The selection of which microlens is to receive incident light is made by using a reflective mask. This mask has a transmission region corresponding to the part of the composite image to be exposed and a reflective region where the image is not to be exposed. Due to the size of the lens array in the horizontal direction, it is not necessary to draw the image using a plurality of light pulses.

By completely irradiating the mask with incident energy, the portion of the mask which enables the passage of energy forms many individual cones of highly dispersed light drawing the contour of the floating image as if the image were drawn by a single lens. As a result, an entire composite image can be formed on the microlens sheeting with only a single light pulse. Alternatively, a composite image can be drawn on the array by locally irradiating the lens array using a light ray positioning system (for example, a galvanometer x-y scanner) instead of a reflective mask. Since energy is spatially localized in this method, only a few of the lenslets in the array are irradiated at any given time. The irradiated lenslets irradiate the microlenses to provide cones of light dispersed at the required precision to form a composite image on the microlens sheeting.

The lens array itself can be created from individual lenslets or with an etching method for manufacturing a monolithic lens array. A material suitable for the lenses is one that is non-absorbent at the wavelength of the incident energy. Each of lenses in the array preferably has a numerical aperture larger than approximately 0.3 and a diameter of at least approximately 30 μm and at most approximately 10 mm. These arrays may have an anti-reflection coating for reducing the effect of retroreflection, which can cause internal damage to the lens material. Further, a single lens having an effective negative focal length and dimensions equivalent to those of a lens array can also be used to increase the divergence of light moving away from the array. The shape of each of the lenslets in a monolithic array is selected so that they have a high numerical aperture and provide a large filling factor exceeding approximately 60%.

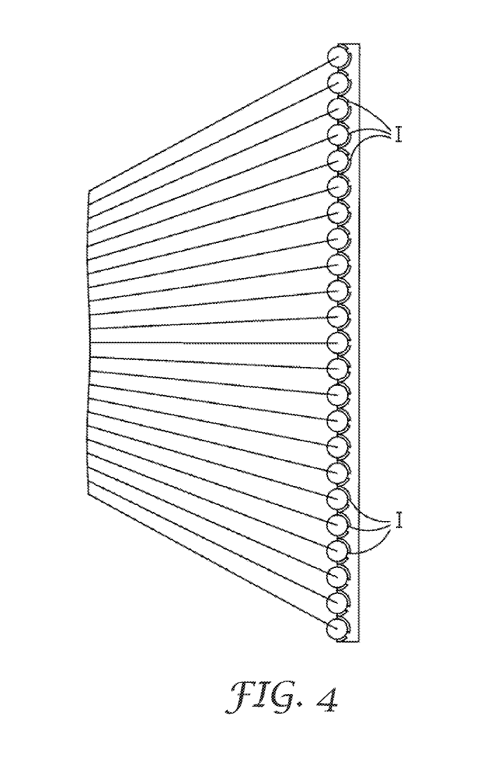

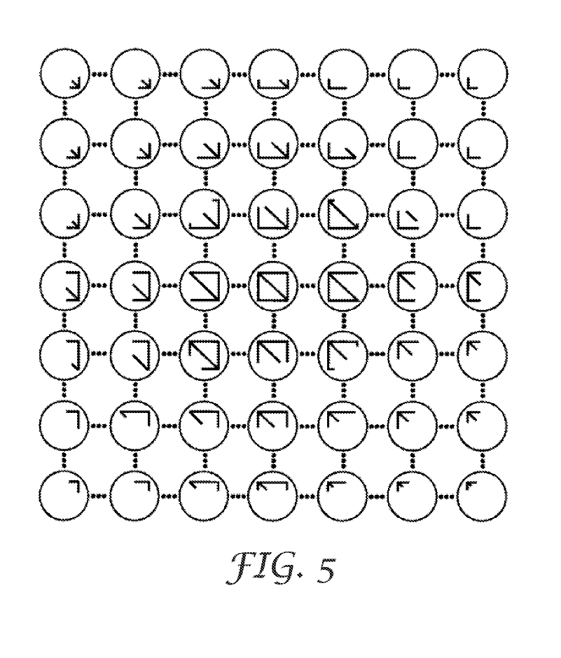

FIG. 4 is a schematic illustration of divergent energy hitting the microlens sheeting. Since each microlens “sees” the incident energy from a different point of view, the portions of the light-sensitive material layer where images I are formed inside or on the surface differ for each microlens. A unique image is thus formed in the portions of the light-sensitive material layer associated with each of the microlenses.

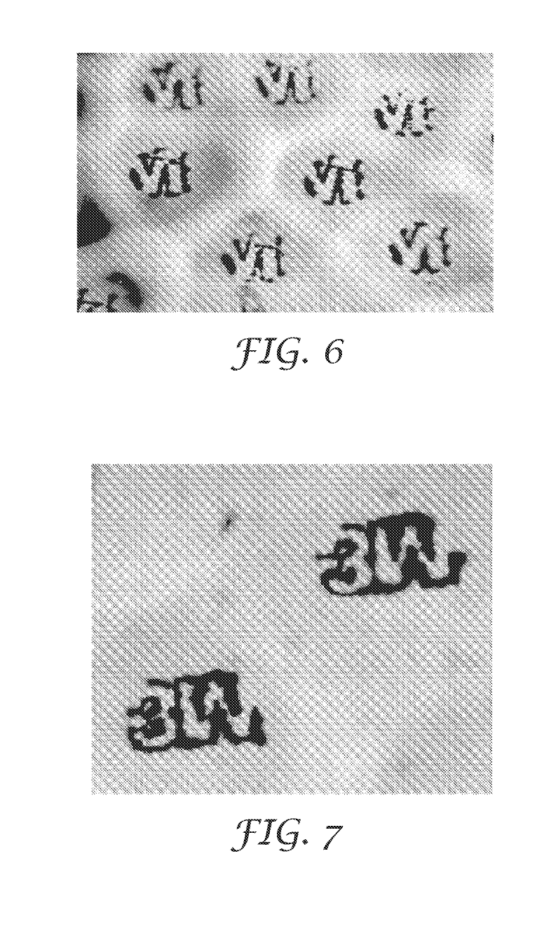

After image formation, a complete or partial image of the object is present in the light-sensitive material layer behind each of the microspheres in accordance with the size of the magnified object. The degree to which the actual object is reproduced as an image behind the microspheres depends on the energy density incident on the microspheres. A part of the magnified object may be at a sufficient distance from the regions of microlenses for which the energy density of the energy incident on the microspheres is lower than the irradiation level required to alter the light-sensitive material. Further, if the spatially magnified images are formed using fixed NA lenses, all of the parts of the microlens sheeting will not necessarily be exposed to the incident light of all of the parts of the magnified object. As a result, these parts of the object are unaltered in the light-sensitive material layer, and partial images of the object appear on the back of the microspheres. FIG. 5 is a perspective view of a part of the microlens sheeting illustrating sample images formed on the light-sensitive material layer adjacent each of the microspheres, and it further shows that the recorded images are within a range from complete reproduction to partial reproduction of the composite image. FIGS. 6 and 7 are optical microscope photographs of a microlens sheeting with an aluminum layer as the light-sensitive material layer, wherein images are formed in accordance with the present disclosure. As shown here, some of the images are complete, but other images are partial images.

These composite images can be considered the result of adding together many images (both partial and complete images, all of which have different points of view of the actual object). The many unique images are formed via an array of microlenses (each of which “sees” the target or an image from a different point). A perspective view of the images dependent on the shape of the image and the direction in which the image forming energy source is received is created in the light-sensitive material layer behind each of the microlenses. However, it is not the case that everything seen by the microlenses is recorded in the light-sensitive material layer. Only parts of the images or the object that can be seen by microlenses having sufficient energy to alter the light-sensitive material are recorded.

The “object” for which an image is to be formed is formed with a powerful light source by drawing the contour of the “object” or using a mask. Light from the object must be emitted over a wide range of angles for images recorded as composite images. If the light emitted from the object originates from a single point of the object and is emitted over a wide range of angles, all of the light rays are from a single point, but they carry information about the object from the viewing angles of the light rays. Here, it will be discussed how, in order to obtain relatively complete information about the object carried by the light rays, the light must be emitted over a wide range of angles from the collection of points forming the object. In the present disclosure, the range of angles of the light rays from the object is controlled by optical elements disposed between the object and the microlenses. These optical elements are selected so that they provide the optimum angle range required to generate a composite image. When the optimum optical elements are selected, the crests of the cones become cones of light ending at the position of the object. The optimum cone angle is greater than approximately 40°.

The object is reduced by the microlenses, and light from the object is focused on the light-sensitive material layer adjacent the back side of the microlenses. The actual positions of spots or images focused on the back side of the microlenses are dependent on the direction of incident light rays originating from the object. Each cone of light emitted from points on the object irradiates some of the microlenses, and only microlenses that are irradiated with light at a sufficient energy permanently record images of the points of the object.

In order to describe the formation of the various composite images of the present disclosure, geometrical optics will be used. As described above, the image formation methods described below are preferable aspects of the present disclosure, but the methods are not limited to these aspects.

A. Forming a Composite Image that Floats Above a Microlens Laminate

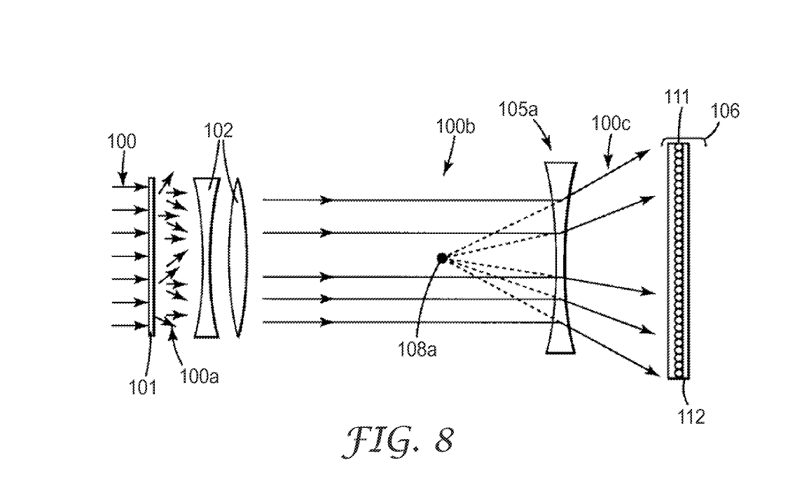

In FIG. 8, incident energy 100 (light in this example) is directed toward a light diffuser 101, and all non-uniformities in the light source are made uniform. Diffusely scattered light 100a is brought together and made parallel by an optical collimator 102, and the optical collimator 102 directs uniformly distributed light 100b toward a diverging lens 105a. Divergent light 100c is emanated from the diverging lens toward a microlens laminate 106.

The energy of light rays hitting the microlens laminate 106 is focused on a light-sensitive material layer 112 by individual microlenses 111. This focused energy alters the light-sensitive material layer 112 to provide an image, and the size, shape, and appearance of the image is dependent on interactions between the light rays and the light-sensitive material layer.

When the divergent light 100c passes through the diverging lens 105a and is extended forward, it intersects at the focal point 108a of the diverging lens, so the arrangement shown in FIG. 8 provides a laminate having a composite image that floats above the laminate to an observer, as described below. In other words, if virtual “image light rays” pass through each of the microspheres from the light-sensitive material layer and advance forward through the diverging lens, they will converge at 108a, which is the location where the composite image appears.

B. Viewing a Composite Image that Floats Above a Microlens Laminate

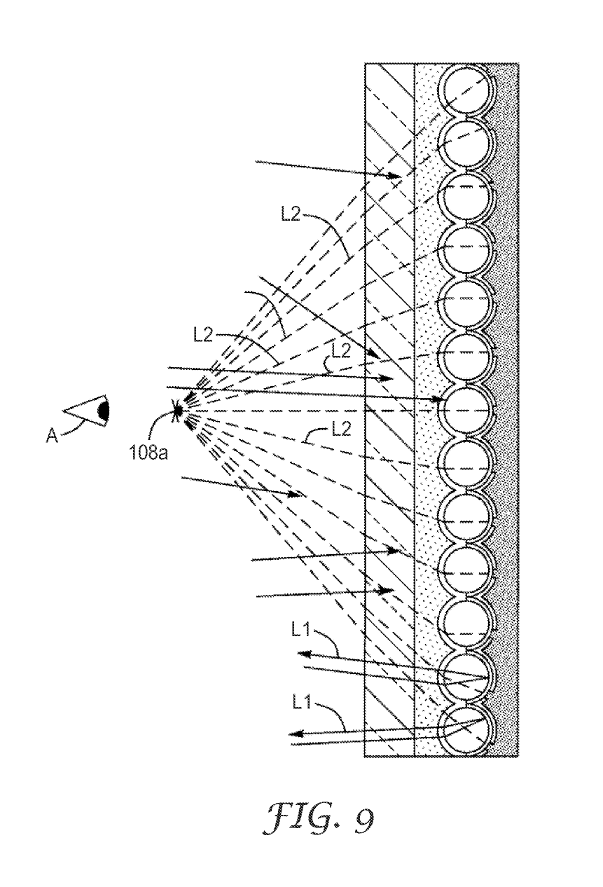

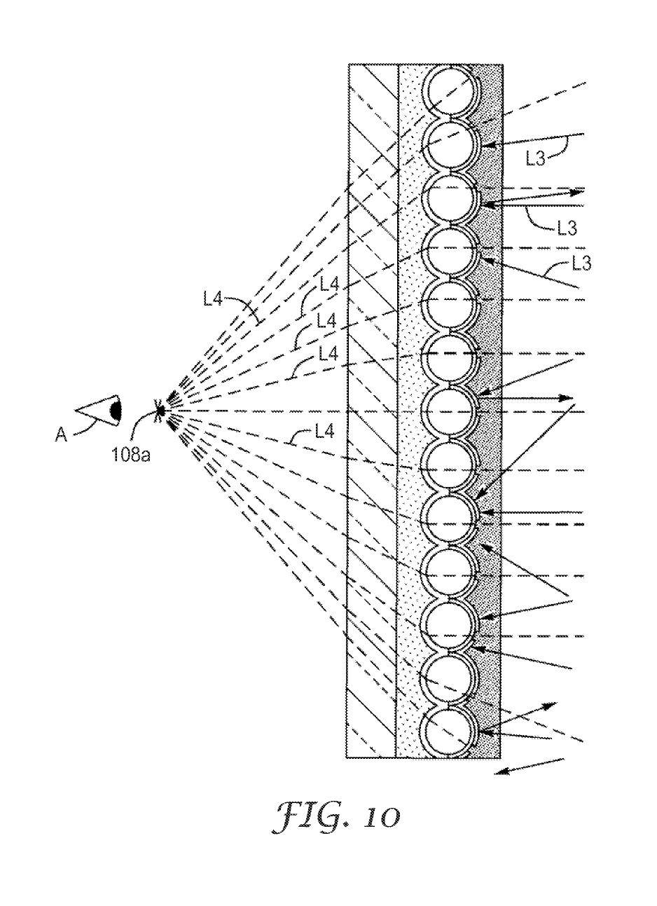

A microlens laminate having a composite image can be viewed using light hitting the laminate from the same side as the observer (reflected light), from the opposite side of laminate as the observer (transmitted light), or from both sides. FIG. 9 is a simplified view of a composite image that floats above the laminate to the naked eye of an observer A when viewed with reflected light, and cases in which the microlens laminate of the aspect shown in FIG. 2 are illustrated in this FIG. 9 as well as in FIGS. 10, 12, and 13 described below. The naked eye may be corrected so that it has normal vision, but it does not resort to any other magnification or special viewers, for example. When the microlens laminate on which an image is to be formed is irradiated with reflected light (this may be parallel light or dispersed light), the light rays are reflected from the microlens laminate on which the image is formed with a pattern determined by the light-sensitive material layer that the light rays hit. The image formed in the light-sensitive material layer looks different from the non-imaged portions of the layer, which allows the image to be recognized.

For example, reflected light L1 is reflected toward the observer by the light-sensitive material layer. However, the light-sensitive material layer does not reflect light L2 sufficiently or at all toward the observer from the imaged portion. The observer can thus detect the absence of light rays at 108a, and the aggregation of the light rays creates a composite image floating above the laminate at 108a. Simply stated, the light is reflected from the entire microlens sheeting with the exception of the imaged portions, and this means that a relatively dark composite image appears at 108a.

The non-imaged portions absorb or transmit incident light, and the imaged portions reflect or partially absorb incident light, which makes it possible to provide the contrast effect required to provide a composite image. In such a state, the composite image appears as a brighter composite image than the remaining portions of the microlens sheeting (which appear to be relatively dark). The image at the focal point 108a is produced by actual light, and there is no lack of light, so this composite image can be called an “actual image”. Various possible combinations of these elements can be selected as necessary.

As shown in FIG. 10, a microlens laminate with an image formed on a part of the laminate can also be viewed with transmitted light. For example, when the imaged portions of the light-sensitive material layer are translucent and the non-imaged portions are not translucent, most light L3 is either absorbed or reflected by the light-sensitive material layer, whereas transmitted light L4 passes through the imaged portions of the light-sensitive material layer and is directed toward the focal point 108a by the microlenses. The composite image is distinct at the focal point and therefore appears to be brighter than the remaining portions of the microlens sheeting in this example. The image at the focal point 108a is produced by actual light, and there is no lack of light, so this composite image can be called an “actual image”.

Alternatively, when the imaged portions of the light-sensitive material layer are not translucent and the remaining portions of the light-sensitive material layer are translucent, the absence of transmitted light in the image regions provides a composite image that appears to be darker than the remaining portions of the microlens sheeting.

C. Creating a Composite Image that Floats Below a Microlens Laminate

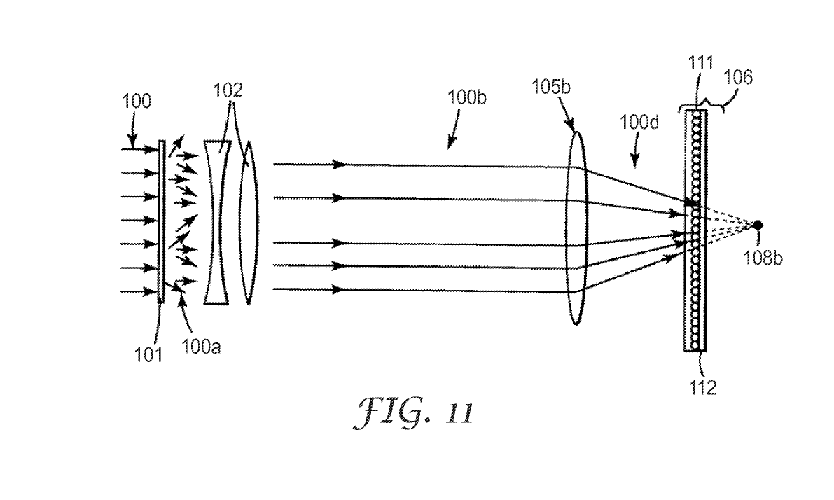

It is also possible to provide a composite image that floats on the opposite side of a microlens laminate from an observer. This floating image, which floats below the laminate, can be created using a converging lens instead of the diverging lens 105a shown in FIG. 8. In FIG. 11, incident energy 100 (light in this case) is directed toward a light diffuser 101, and all non-uniformities in the light source are made uniform. Next, diffused light 100a is brought together and made parallel by an optical collimator 102, and the optical collimator 102 directs uniformly distributed light 100b toward a converging lens 105b. Convergent light 100d is incident on a microlens laminate 106 (which is placed between the converging lens and the focal point 108b of the converging lens) from the converging lens.

The energy of light rays hitting the microlens laminate 106 is focused on a light-sensitive material layer 112 by individual microlenses 111. This focused energy alters the light-sensitive material layer 112 to provide an image, and the size, shape, and appearance of the image is dependent on interactions between the light rays and the light-sensitive material layer. When the convergent light 100d passes through the microlens laminate 106 and is extended backward, it intersects at the focal point 108b of the converging lens, so the arrangement shown in FIG. 11 provides a laminate having a composite image that floats below the laminate to an observer, as described below. In other words, if virtual “image light rays” pass through each of the microspheres from the converging lens 105b and advance through the image in the light-sensitive material layer associated with each of the microlenses, they will converge at 108b, which is the location where the composite image appears.

D. Viewing a Composite Image that Floats Below a Microlens Laminate

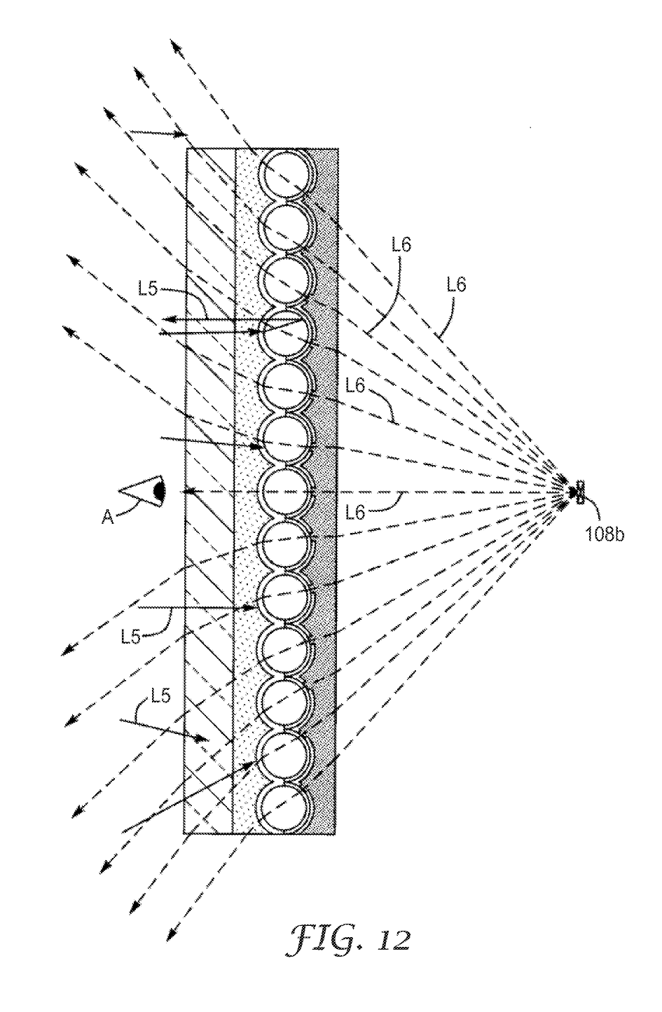

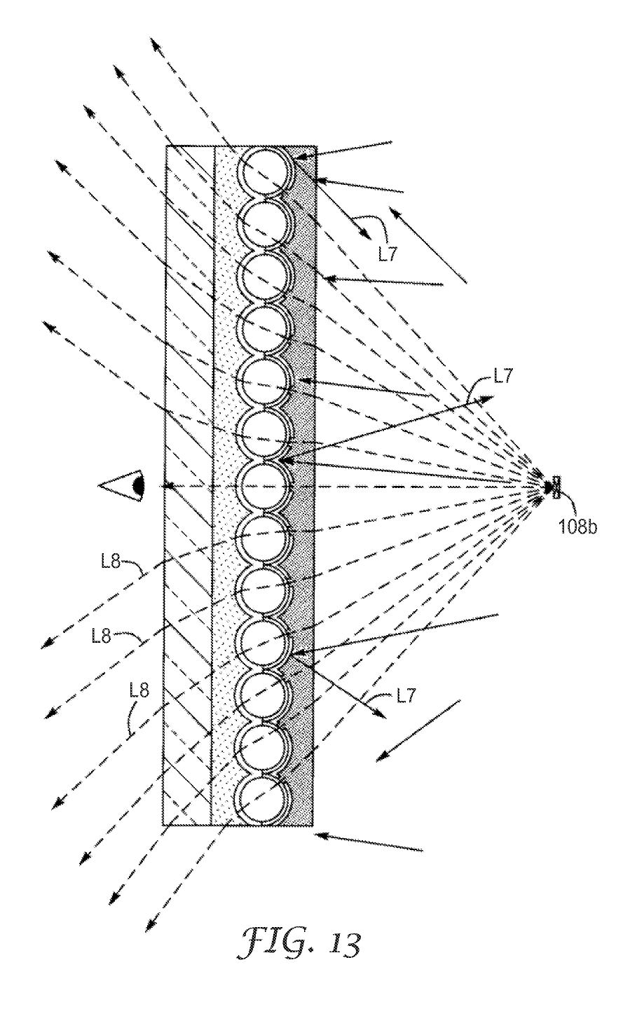

A microlens laminate having a composite image that floats below the laminate can be viewed with reflected light, transmitted light, or both. FIG. 12 is a simplified view of a composite image that floats below the laminate when viewed with reflected light. For example, reflected light L5 is reflected from a light-sensitive material layer toward an observer. However, the light-sensitive material layer does not reflect light L6 sufficiently or at all toward the observer from the imaged portion. The observer can thus detect the absence of light rays at 108b, and the aggregation of the light rays creates a composite image floating below the laminate at 108b. Simply stated, the light is reflected from the entire microlens sheeting with the exception of the imaged portions, and this means that a relatively dark composite image appears at 108b.

The non-imaged portions absorb or transmit incident light, and the imaged portions reflect or partially absorb incident light, which makes it possible to provide the contrast effect required to provide a composite image. In such a state, the composite image appears as a brighter composite image than the remaining portions of the microlens sheeting (which appear to be relatively dark). Various possible combinations of these elements can be selected as necessary.

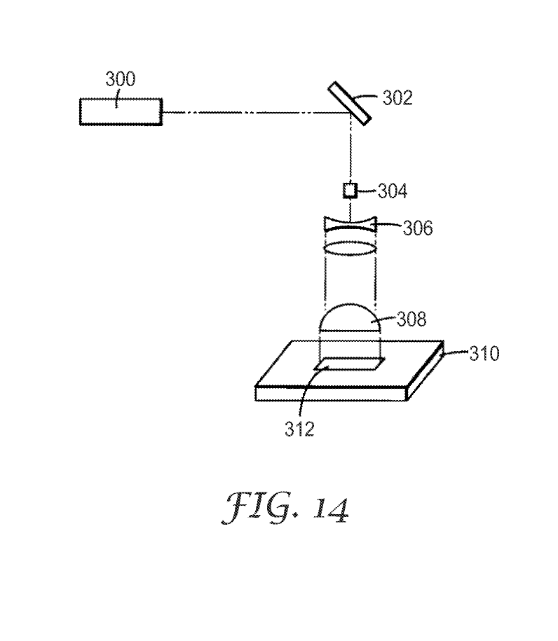

As shown in FIG. 13, a microlens laminate with an image formed on a part of the laminate can also be viewed with transmitted light. For example, when the imaged portions of the light-sensitive material layer are translucent and the non-imaged portions are not translucent, most light L7 is either absorbed or reflected by the light-sensitive material layer, whereas transmitted light L8 passes through the imaged portions of the light-sensitive material layer. When light rays called “image light rays” which return in the direction of the incident light in this specification are extended, a composite image is formed at 108b. The composite image is distinct at the focal point and therefore appears to be brighter than the remaining portions of the microlens sheeting in this example.

Alternatively, when the imaged portions of the light-sensitive material layer are not translucent and the remaining portions of the light-sensitive material layer are translucent, the absence of transmitted light in the image regions provides a composite image, which appears to be darker than the remaining portions of the microlens sheeting.

### E. Composite Images

Composite images created in accordance with the principle of the present disclosure appear in two dimensions (meaning that they have length and width and appear below, in the plane of, and/or above the microlens laminate) or in three dimensions (meaning that they have length, width, and height). A three-dimensional composite image may appear only below or only above the laminate, or as a combination below, in the plane of, and above the laminate as necessary. The term “in the plane of the (microlens) laminate” generally refers to the surface and interior of the laminate when it is placed flatly. That is, a laminate that is not flat can also have a composite image that appears as if it is at least partially “in the plane of the laminate”.

A three-dimensional composite image appears not only at a single focal point, but also appears as the composite of images having consecutive focal points, and the focal point may pass through the microlens laminate from one side of the laminate and reach a point on the opposite side. This is preferably implemented by continuously moving either the microlens sheeting or the energy source toward the other (not providing a plurality of different lenses) so that an image is formed on the light-sensitive material layer at a plurality of focal points. The spatially complex image that is obtained essentially consists of many separate dots. This image can have a spatial spread to any coordinates from among the three Cartesian coordinates with respect to the plane of the microlens laminate.

As another type of operation, a composite image can be formed so that it moves into the region of the microlens laminate (here, the composite image disappears). This type of image is formed with a method similar to that of the example of the floating image, with the addition of placing an opaque mask so that it touches the microlens sheeting or the microlens laminate to partially block the light for image formation that is incident on some of the microlenses. By doing so, it is possible to create a composite image that appears to move into a region in which the light for image formation decreases or disappears due to the opaque mask. This image appears “to disappear” in this region.

A composite image formed in accordance with the present disclosure can have an extremely wide range of viewing angles, which means that an observer can view the composite image at a wide range of angles between the plane of the microlens sheeting and the visual axis. A composite image formed when a non-spherical lens with a numerical aperture of 0.64 is used in a microlens sheeting having a single layer of microlenses made of glass microspheres having an average diameter of approximately 70-80 μm can be visually recognized within a conical field of view (the central axis of which is determined by the optical axis of the incident energy). Under ambient light, a composite image formed in this way can be viewed across a cone with a full angle of approximately 80-90°. When image forming lenses that are small or have a low NA due to diffusion are used, a cone with an even smaller half angle can be formed.

An image formed by the method of the present disclosure can also be configured so that it has a limited viewing angle. That is, the image can only be seen when observed from a specific direction or from an angle varying slightly from this direction. Such an image is formed in the same manner as with the method described in the following embodiments, with the exception that the adjustment of the light incident on the final non-spherical lens is omitted so that only parts of the microlenses are irradiated by laser light. When a non-spherical lens is partially full of incident energy, a limited cone of divergent light is produced so that the light is incident on the microlens sheeting. In a microlens laminate having an aluminum light-sensitive material layer, the composite image appears only within the limited viewing angle cone as a dark gray image on a light gray background. This image is floating with respect to the microlens laminate.

The microlens laminate having a composite image according to the present disclosure is unique and cannot be replicated with an ordinary device. The microlens laminate of the present disclosure is used as a display material for various applications in which there is a need for the visual display of a unique image, ranging from applications related to relatively small objects such as emblems, tags, recognition badges, recognition graphics and affiliated credit cards to applications related to relatively large objects such as advertisements and license plates. By incorporating a composite image as a part of a design, advertisements or information on large objects (for example, signs, billboards, or semi trailers) will attract even greater attention.

In addition, the microlens laminate having a composite image according to the present disclosure has an extremely strong visual effect even under ambient light, transmitted light, or retroreflected light, and decorations can further be applied to the transparent material layer, so it can be used for decorative applications to improve the appearance of an object to which the microlens laminate is adhered or attached. Such decorative applications include clothing items such as casual wear, sporting apparel, designer clothing, coats, footwear, hats (caps and hats) and gloves, accessories such as wallets, billfolds, briefcases, backpacks, fanny packs, computer cases, travel bags and notebooks, books, household appliances, electronics, hardware, vehicles, sporting goods, collectibles, and works of art.

If the microlens laminate of the present disclosure is retroreflective, it can be used in applications for the purpose of safety or personal protection. Such applications include occupational safety apparel such as vests, uniforms, firefighter apparel, shoes, belts, and safety helmets, for example; sporting goods and apparel such as running equipment, shoes, life jackets, protective helmets, and uniforms; and safety clothing for children.

### EXAMPLES

The microlens laminate of the present disclosure will be further described using the following embodiments.

Creation of a Transparent Material Decorated with Hot Stamp Foil
A transparent material decorated with hot stamp foil was created. The materials, apparatus, and stamping conditions are as follows.
Substrate: Polymethylmethacrylate (PMMA, 85 mm×55 mm×2 mm)
Hot stamping foil: TA type hologram foil (made by Katani Sangyo Co., Ltd.) VA type gold foil (made by Katani Sangyo Co., Ltd.)
Apparatus: Hot stamping apparatus T-4A3-E-175 (made by Amagasaki Machinery Co., Ltd.)
Stamp: Etching metal stamp (made by Katani Sangyo Co., Ltd.)
Stamping conditions: Stamping temperature of 200° C., stamping time of approximately 0.5 seconds

### A. Creation of a Microlens Laminate for a 3D Floating Image Using an Optically Clear Adhesive

A microlens laminate for a 3D floating image was created by adhering a retroreflective material (3M Scotchlite (registered trademark) reflective material 680-10, made by Sumitomo 3M Ltd.) and a transparent material (PMMA having a stamp decoration created as described above or PMMA with no decoration) using film-like or liquid optically-clear adhesives (OCA, Optically Clear Adhesives). The retroreflective material that was used had the same structure as the microlens sheeting 21 shown in FIG. 2. The OCA adhesives that were used were as follows:
CEF 0807 (highly transparent acrylic pressure-sensitive adhesive, made by Sumitomo 3M Ltd.)
Liquid OCA 2312 (highly transparent UV-setting acrylic adhesive, made by Sumitomo 3M Ltd.)

### Example 1

A microlens laminate was created by laminating CEF 0807 on a transparent material (no stamp decoration) and then bringing a coating layer (binder layer) for microlenses made of a retroreflective material into contact with the CEF 0807.

### Example 2

A microlens laminate was created by laminating CEF 0807 on a transparent material (with a stamp decoration) and then bringing a coating layer (binder layer) for microlenses made of a retroreflective material into contact with the CEF 0807.

### Example 3

A retroreflective material was attached to a PMM substrate via an adhesive layer made of a retroreflective material, and liquid OCA 2312 was then applied to a coating layer (binder layer) for microlenses made of a retroreflective material. Next, a transparent material (no stamp decoration) was disposed on the applied liquid OCA and pressed to a thickness of approximately 200 μm. A microlens laminate was created by then hardening the liquid OCA by irradiating it with ultraviolet rays using a black light (TLD15W, PHILIPS Co., LTD.).

### B. Creation of a Microlens Laminate for a 3D Floating Image by Directly Molding a Transparent Material Layer

### Example 4

A mixed urethane premix was created using the polyol, isocyanate, and catalyst described below at a ratio of 100:53:0.1. The premix was injected into a die and laminated so that the coating layer side of microlenses made of a retroreflective material made contact with the urethane premix. After heating for 3 minutes at 100° C., followed by removal from the die, a microlens laminate with a transparent material layer molded directly on the microlens sheeting was formed.
Polyol: Polylite OD-X-2580 (made by Dainippon Printing Co., Ltd.)
Isocyanate: Duranate T5900-100 (made by Asahi Kasei Chemicals Corporation)
Catalyst: Dibutyl tin dilaurate (made by Wako Pure Chemical Industries, Ltd.)

### Comparative Example 1

A laminate prepared by attaching a retroreflective material to a PMMA substrate via an adhesive layer made of a retroreflective material was used as a control sample. A retroreflective coating layer (binder layer) for microlenses was exposed.

### Formation of 3D Floating Images

3D floating images were drawn on the microlens laminates of examples 1-4 and the control sample of comparative example 1 using an optical system array (train) of the type described in FIG. 14. The optical system array consists of a Spectral Physics Quanta-Ray (brand name) DCR-2 (10) Nd:YAG laser 300, which operates in a Q-switched mode at a fundamental wavelength of 1.06 μm. The pulse width of this laser is typically 10-30 ns. Following the laser, the orientation of the energy was changed by a 99% reflective turning mirror 302, a ground glass diffuser 304, a 5× light ray magnification telescope 306, and a non-spherical lens 308 with a numerical aperture of 0.64 and a focal length of 39.00 mm. The orientation of the light from the non-spherical lens 308 was changed to the direction of an XYZ stage 310. The stage consists of three linear stages and can be acquired from Aerotech Inc. (Pittsburgh, Pa.) under the brand name ATS50060. The first linear stage was used to move the non-spherical lens along the axis (z-axis) between the non-spherical surface focal point and the microlens laminate, and the other two stages made it possible to move the laminate along two horizontal axes orthogonal to one another with respect to the optical axis.

The laser beam was directed toward the glass diffuser 304 to eliminate non-uniformities in the light rays caused by the thermal lens effect. The 5× light ray magnification telescope 306 immediately adjacent to the diffuser made the divergent light from the diffuser parallel, and it fully illuminated the non-spherical lens 308 by magnifying the light rays.

In this example, the non-spherical lens was disposed above the XY plane of the XYZ stage so that the focal point of the lens was 1 cm above the microlens laminate 312. The energy density on the surface of the laminate was controlled using an energy meter provided with an opening and having a mechanical mask, which can be acquired from Gentec, Inc. (Saint-Fey, Quebec, Canada) under the brand name ED500. The laser output was adjusted to approximately 8 millijoules per square centimeter (8 mJ/cm2) across the irradiation region of the energy meter at a location 1 cm from the focal point of the non-spherical lens. A sample of the microlens laminate 312 having an aluminum layer with a thickness of 100 nm as a light-sensitive material layer was attached to the XYZ stage 310 so that the aluminum layer side faced the opposite direction as the non-spherical lens 308.

A controller that can be acquired from Aerotech, Inc. (Pittsburgh, Pa.) under the brand name U21 supplied a control signal required to move the XYZ stage 310 and a control voltage for the pulsing of the laser 300. The stage was moved by importing a CAD file to a controller provided with x-y-z coordinate information, movement commands, and laser emission commands required to create an image. A composite image of a prescribed complexity was formed by harmonizing the movement of the X, Y, and Z stages with the pulse generation of the laser and drawing an image in the space above the microlens laminate. The stage speed was adjusted to 50.8 cm/minute for a laser pulse speed of 10 Hz. As a result, continuous composite lines were formed in the aluminum layer adjacent the microlens layer.

### Appearance Test

The coating layer of the microlenses made of a retroreflective material in the control sample of comparative example 1 remained exposed, and there were small concavities and convexities resembling an orange peel on the surface thereof. On the other hand, the microlens laminates of examples 1-4 had flat surfaces with high luster. In addition, when these microlens laminates were viewed under ambient light, the composite images were lines of bright white light on a black background, and they appeared to be present from the front (observer side) to the back (back side of the microlens laminate) from the microlens laminate. Further, the composite images demonstrated comparatively large movements with respect to the viewpoint of the observer, and the observer was able to easily view portions of the composite images that differed depending on the viewing angle. No effects on the formation or observation of the 3D floating images were observed as a result of laminating a transparent material layer and, as necessary, OCA on the coating layer of the microlenses.

Various modifications of the disclosed aspects and combinations thereof, which would be obvious to a person skilled in the art, are included in the scope of the present disclosure as defined within the scope of the attached patent claims.

1. A microlens laminate capable of providing a composite image that floats above, in the plane of, and/or below the laminate, the microlens laminate comprising:
a microlens sheeting comprising a microlens layer composed of a plurality of microlenses, the microlens layer having first and second sides, and
a light-sensitive material layer disposed adjacent the first side of the microlens layer; and a transparent material layer disposed at the second side of the microlens layer in the microlens sheeting.

2. The microlens laminate according to claim 1, wherein the transparent material layer is attached to the second side of the microlens layer in the microlens sheeting via an optically clear adhesive layer.

3. The microlens laminate according to claim 2, wherein the optically clear adhesive layer comprises an optically clear pressure sensitive adhesive, a liquid optically clear adhesive or a hot melt optically clear adhesive.

4. The microlens laminate according to claim 1, wherein the transparent material layer is directly formed on the microlens sheeting at the second side of the microlens layer.

5. The microlens laminate according to claim 1, comprising at least partially complete images formed in the light-sensitive material layer, each image associated with a respective microlens of the plurality of microlenses; and a composite image that floats above, in the plane of, and/or below the laminate, the composite image provided by the individual images.

6. The microlens laminate according to claim 1, wherein the transparent material layer comprises a visibility enhancer selected from the group consisting of a light diffusion material and combinations thereof.

7. A method of making a microlens laminate capable of providing a composite image that floats above, in the plane of, and/or below the laminate, the method comprising:
providing a microlens sheeting comprising a microlens layer composed of a plurality of microlenses, the microlens layer having first and second sides, and a light-sensitive material layer disposed adjacent the first side of the microlens layer;
providing a transparent material layer; and attaching the transparent material layer to the microlens sheeting at the second side of the microlens layer with an optically clear adhesive layer to form a microlens laminate.

8. The method according to claim 7, wherein the optically clear adhesive layer comprises an optically clear pressure sensitive adhesive, a liquid optically clear adhesive or a hot melt optically clear adhesive.

9. A method of making a microlens laminate capable of providing a composite image that floats above, in the plane of, and/or below the laminate, the method comprising:
providing a microlens sheeting comprising a microlens layer composed of a plurality of microlenses, the microlens layer having first and second sides, and a light-sensitive material layer disposed adjacent the first side of the microlens layer; and
directly forming a transparent material layer on the microlens sheeting at the second side of the microlens layer to form a microlens laminate.

10. The method according to claim 7, further comprising irradiating the second side of the microlens layer, to form at least partially complete images in the light-sensitive material layer, each image associated with a respective microlens of the plurality of microlenses, whereby the individual images provides a composite image that floats above, in the plane of, and/or below the laminate.

11. The method according to claim 10, wherein the irradiating step is carried out after formation of a microlens laminate.
